(19) United States
(12) Patent Application Publication
(10) Pub. No.: US 2018/0188695 A1
(43) Pub. Date: Jul. 5, 2018

(54) USER LOCATION AND ACTIVITY BASED SMART REMINDERS

(71) Applicant: QUALCOMM Incorporated, San Diego, CA (US)

(72) Inventors: Akash KUMAR, Hyderabad (IN); Arvind MISHRA, Hyderabad (IN); Ankit MAHESHWARI, Hyderabad (IN)

(21) Appl. No.: 15/395,752

(22) Filed: Dec. 30, 2016

(51) Int. Cl. G04G 21/02; H04W 4/02; H04W 16/22; G04G 21/04; G04G 13/02

(52) U.S. Cl. CPC G04G 21/02; H04W 4/028; G04G 13/02; G04G 21/04; H04W 16/22

(57) ABSTRACT

In one aspect, an apparatus for scheduling are provided. The apparatus may detect a user activity. The apparatus may estimate a finish time of the user activity. In response to determining the estimated finish time falls behind the start time of a scheduled event, the apparatus may issue an alert about a conflict of the activity with the scheduled event. In another aspect, an apparatus for managing activities are provided. The apparatus may receive a navigation request to a destination and an indication to participate in a phone call while traveling to the destination. The apparatus may provide a route from the current location of the user to the destination. The apparatus may estimate wireless communication coverage conditions along the route. The apparatus may further issue an alert about zones of wireless communication coverage weaker than a threshold based on the wireless communication coverage conditions along the route.

### BACKGROUND

### Field

The present disclosure relates generally to calendar and reminder systems, and more particularly, to managing reminders based on user location and activity.

### Background

Traditional meeting reminders often remind users of upcoming meeting at a predefined fix lead time ahead of the start time of the meeting. A typical lead time is usually set at fifteen minutes before the meeting. However, this does not take into account travel times since the reminder system cannot accurately know or predict the location of the user. Reminder systems also do not have access to information to calculate the time that it will take the user to travel to the venue so that the reminder can be raised at the correct time.

Traditional reminder systems mentioned above provide reminders depending on how they are configured. Traditional approach often ignores what the user is acting at the moment, which may cause the user to be less receptive and responsive due to the user being engaged in other activities. For example, wake up alarms do not usually take into account of a user's activity when sounding the alarm, even if the user is already awake.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In aspects of the disclosure, a method, a computer-readable medium, and an apparatus for managing activities are provided. The apparatus may receive, from a user, a navigation request to a destination and an indication to participate in a phone call while traveling to the destination. The apparatus may determine a current location of the user. The apparatus may provide a route from the current location of the user to the destination. The apparatus may estimate wireless communication coverage conditions along the route.

In some aspects, the apparatus may further receive a schedule for the phone call. The apparatus may estimate a time of arrival to the destination from current location of the user. In response to determining that the estimated time of arrival is ahead of the start time of the phone call, the apparatus may determine that the phone call is to be participated after arriving at the destination. The apparatus may further determine a reminder time based at least in part on the estimated time of arrival. The apparatus may send a reminder at the determined reminder time.

In some aspects, the current location of the user is determined via the apparatus. The time of arrival may be estimated based on at least one of a traffic condition between the current location of the user and the destination, a weather condition, or a type of transportation. The wireless communication coverage conditions along the route may be estimated based on information collected from at least one of a search engine, a service provider, or a navigation service. The apparatus may further issue an alert about zones of wireless communication coverage weaker than a threshold based on the wireless communication coverage conditions along the route. The apparatus may provide one or more new routes with increased wireless communication coverages.

In aspects of the disclosure, a method, a computer-readable medium, and an apparatus for scheduling are provided. The apparatus may detect a user activity associated with the apparatus. The apparatus may estimate a finish time of the user activity. In response to determining the estimated finish time falls behind the start time of a scheduled event, the apparatus may issue an alert about a conflict of the activity with the scheduled event.

In aspects of the disclosure, a method, a computer-readable medium, and an apparatus for scheduling are provided. The apparatus may obtain the current location of a user and a location of a first event to be scheduled. The apparatus may determine an estimated first travel time between the location of the first event and the user's current location. The apparatus may determine a reminder time based on the estimated first travel time. The apparatus may determine whether the reminder time has been reached. The apparatus may send the reminder to the user if the reminder time has been reached.

The apparatus may receive a second event to be scheduled. The apparatus may estimate a second travel time between the location of the first event and the location of the second event. The apparatus may determine whether the second travel time is longer than the gap between the two events. The apparatus may notify the user of a potential conflict between the first event and the second event if the second travel time is longer than the gap between the two events.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of network environment for user location and activity based smart reminder system, in accordance with aspects of the disclosure.

FIG. 2 is a block diagram illustrating components of an example mobile computing device configured to provide location and activity based smart reminder to a user on a device accessible by the user, in accordance with aspects of the disclosure.

FIG. 3 is a block diagram illustrating components of an example smart reminder application configured to provide a location and activity based reminder, in accordance with aspects of the disclosure.

FIG. 4 is a flowchart illustrating an example process for scheduling, in accordance with aspects of the disclosure.

FIG. 5 is a flowchart illustrating an example process for managing activities, in accordance with aspects of the disclosure.

FIG. 6 is a flowchart illustrating an example process for scheduling, in accordance with aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of computing systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

The following detailed description is directed to using location and activity information of a user in the context of a scheduled event, such as a meeting, a phone call, an appointment, in order to provide smart reminder systems and services. Location and activity based reminder system is facilitated by determining location and activity information of the user, and/or information on the schedule event. Location and activity information of the user can be obtained, in some instances, by a mobile device, a wearable device and a smart home device associated with the user reporting the location and activity. For example, smartphones and tablet computers nowadays incorporate GPS technology allowing determination of the user's location, and smartwatch or a fitness equipment can actively monitor user activities. This information can be sent by the mobile device, the wearable device and the smart home devices to other systems that in turn use the location and activity information to provide smart reminders.

In the following detailed description, references are made to the accompanying drawings that form a part hereof, and which are shown by way of illustration of specific embodiments or examples. Referring now to the drawings, in which like numerals represent like elements throughout the several figures, aspects of a system for providing smart reminders are provided.

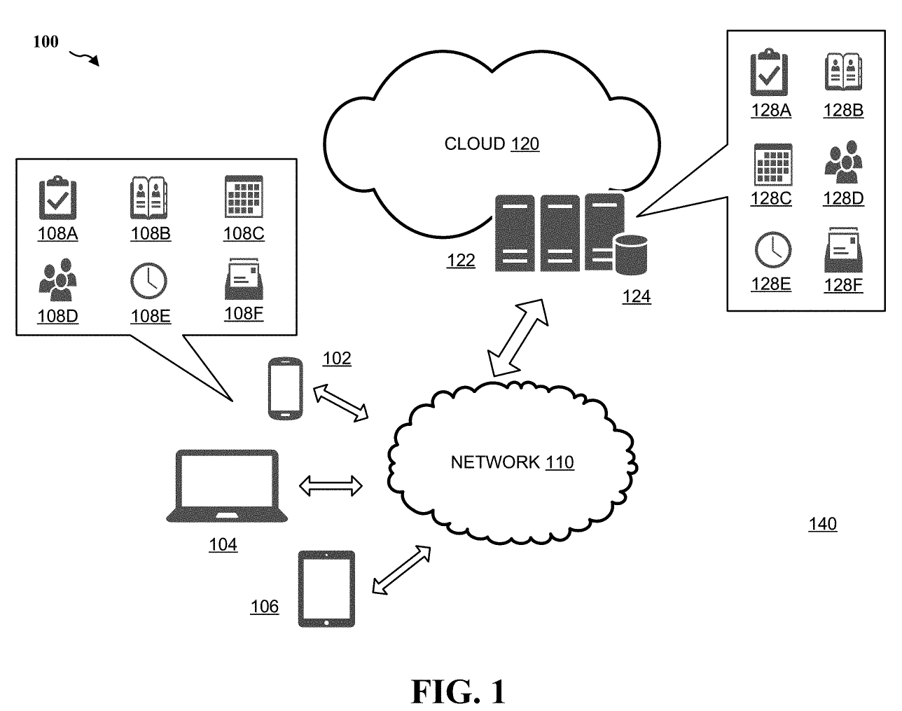

FIG. 1 is a diagram illustrating an example of network environment 100 or user location and activity based smart reminder system, in accordance with aspects of the disclosure. The network environment 100 of FIG. 1 shows various types of user devices that can be used in conjunction with the smart reminder system and/or service. The user device may include, for example, a smart phone 102 that is connected to a communication network 110, such as the Internet, which in turn is connected to a cloud computing environment 120. The smart phone 102 may communicate via a wireless connection, which can be based on various technologies, including but not limited to: GSM, EDGE, CDMA, 3G, 4G, LTE, 5G, Wi-Fi, etc. A tablet computer 106 can also be used, which can access the network 110 via a wireless connection, including cellular, Wi-Fi, or other wireless technologies.

In addition, the user may use a laptop 104 connected through a wired connection to the network 110. The wired connection may be accomplished, using various technologies, including using a cable modem, DSL adaptor, Wi-Fi adaptor, or any other technology for accomplishing an Internet data connection. The smart phone 102, laptop 104, and tablet computer 106 are only some of the types of devices that can be used in accessing the smart reminder system. Other device types, such as wearable devices including a smartwatch, a health monitoring and activity tracking device, may also be connected to the communication network 110 directly or indirectly (through other electronic devices) and be part of the smart reminder system.

The user devices may interact with the cloud computing environment 120. The cloud computing environment may include servers 122 and storage devices 124. The servers 122 may include a variety of server technologies, including distributed processing systems, blade servers, and parallel processing servers. The servers access storage devices 124, which may include various types of solid state memory and hard disk storage systems. The storage devices 124 may be used to store data for various applications.

In one aspect of the disclosure, the user devices may access one or more application programs 128 executing on the servers 122 in the cloud computing environment 120. The application programs 128 may include a reminder/schedule application 128A, a contacts application 128B, a calendar application 128C, a social media application 128D, an alarm/clock application 128E, and messaging applications 128F. The messaging applications 128F may include an email application, a text messaging application, a voice chat application, a video chat application, and a web conferencing application. Other types of messaging applications may include streaming applications providing various media streaming services.

The contacts application 128B may maintain and organize contact information. The calendar application 128C, may maintain meeting or other activity information scheduled for a user. For example, the calendar application 128C may maintain information about a meeting or an appointment, which may include scheduled meeting time, the invited attendees, the meeting location, and the purpose of the meeting or appointment. The reminder/schedule application 128A may interact, or be integrated with, the contacts application 128B, the calendar application 128C, the social media application 128D, the alarm/clock application 128E and one or more messaging applications 128F to extract information related to scheduled events, meeting invitations, appointments, notices and activities. The extended information may be used for generating timely reminders based on user location and activity. The reminder/schedule application 128A may also have access to location information of the user as well as scheduled events, communication devices associated with the user, and other attendees' contact information. Thus, the reminder/schedule application 128A may determine whether the user is attending in person, via video conference, or by some other arrangement. All of these applications may maintain information for various users, which may be stored on the servers 122 or on the storage devices 124.

In some implementations, the same or similar application programs 108 may be executed on computing devices 102, 104, and 106. For example, the application programs 108 may include client versions of a reminder/schedule application 108A, a contacts application 108B, a calendar application 108C, a social media application 108D, an alarm/clock application 108E, and one or more messaging applications 108F. The application programs 128 on the server 122 may synchronize information stored by the application programs 108 on a particular device or between multiple devices associated with a user, such as the smart phone 102, laptop 104, and/or the tablet computer 106.

In other implementations, the user devices may or may not access the cloud computing environment 120 to provide smart reminders to the user on the device(s). The application programs 108 may be executed by a processor and data may be stored in a memory in the user device(s). Other configurations are possible for performing the processes disclosed herein including using a variety of computer devices.

In one example, the server 122 maintains information for a set of users that are invited attendees of a scheduled meeting. Specifically, the calendar application 128C maintains information for the scheduled meeting on the corresponding calendars for the attendees. The calendar application 128C may also maintain location information for each attendee, or access other servers which may maintain the location information. The application programs 128 may also access application programs executing on the same server or other servers. For example, application programs 128 may query a search engine, which may provide search results to the server 122 regarding given locations, traffic conditions, weather conditions, airport delays, among other search results for each attendee.

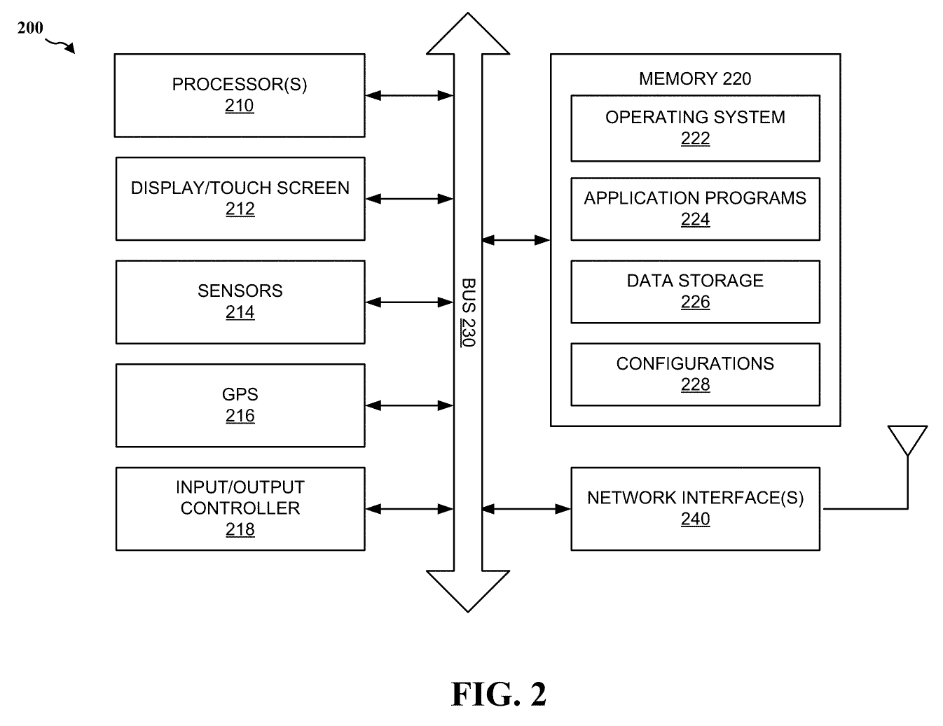

FIG. 2 is a block diagram illustrating components of an example electronic device 200 configured to provide a location and activity based smart reminder to a user on a device accessible by the user, in accordance with aspects of the disclosure. The example electronic device may include the smart phone 102, the laptop 104, the tablet computer 106, or some other type of device, such as a wearable device. Other components or architectures may also be used to execute the smart reminder applications presented herein.

In one configuration, the example electronic device may be a user equipment (UE). Examples of UEs include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, or any other similar functioning device. The UE may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The computing device architecture shown in FIG. 2 may include one or more processors 210, a memory 220, which may include volatile storage, such as random access memory (“RAM”), and non-volatile storage, such as read-only memory (“ROM”), and a system bus 230 that couples the memory 220 and other components to the one or more processors 210. The memory 220 may further stores an operating system 222, application programs 224, which may include the application programs 108, a data repository 226 for storing application data, such as automatically generated reminders, and device configurations 228 for configuring various functionalities of the computing device. Other application programs and data may also be stored in memory 220. The memory 220 may be connected to the one or more processors 210 through a controller (not shown in FIG. 2), which in turn is connected to the system bus 230.

The electronic device 200 may connect to the network through one or more network interfaces 240, which are also coupled to the bus 230. The network interfaces 240 may include a radio interface for wireless local area network (LAN) based on IEEE 802.11 standards. It should be appreciated that the one or more network interfaces may also utilize a variety of wired and/or wireless technologies to connect to other types of networks and remote computer systems.

An input/output controller 218 may be used for receiving and processing input from a number of devices, such as keys, buttons, stylus, and interfaces for connecting a keyboard and/or a mouse (not shown in FIG. 2). Similarly, the input/output controller 218 may provide output to a display screen or some other type of output device. In some implementations, the computing device may incorporate a touch screen display 212, which may display information and receive input, including text, commands, and control information.

The electronic device 200 may include one or more sensors 214 for capturing user activity information, biometric information, images and videos, among other information. The one or more sensors may include motion sensors, such as an accelerometer for measuring acceleration, a gyroscope for measuring orientation, or a combination thereof. Alternatively or in addition, the one or more sensors may include biometric sensors for obtaining the user's biometric information, such as heart rate, blood pressure, and skin colorization. The electronic device 200 may also include one or more cameras, such as photo cameras or video cameras, for voice/video messaging, voice/video conferencing, and/or recording images, voice information or videos relating to the user's activities.

The electronic device 200 may also incorporate a GPS module 216 capable of receiving GPS signals and determining a location of the electronic device 200. The electronic device 200 may also incorporate an audio interface, such as a microphone, a speaker, and an earphone port, for effecting voice communications and voice control functions. The electronic device 200 may also incorporate one or more visual indicators, such as LEDs.

It should be appreciated that the software components described herein may, when loaded into the one or more processors 210 and executed, transform the processors 210 and the overall electronic device 200 from a general-purpose computing system into a special-purpose computing system customized to facilitate the functionality presented herein. More specifically, the processors 210 may operate as a finite-state machine, in response to executable instructions contained within the software modules disclosed herein. These computer-executable instructions may transition the processors 210 between states.

It also should be appreciated that the electronic device 200 may include other types of computing devices, including server computers, desktop computers, embedded computer systems, e-book readers, set-top boxes, personal digital assistants, and other types of computing devices operative to provide location and activity based smart reminder on a user device in accordance with aspects of the disclosure herein. The electronic device 200 may not include all of the components shown in FIG. 2, may include other components that are not explicitly shown in FIG. 2, or may utilize an architecture different than that shown in FIG. 2.

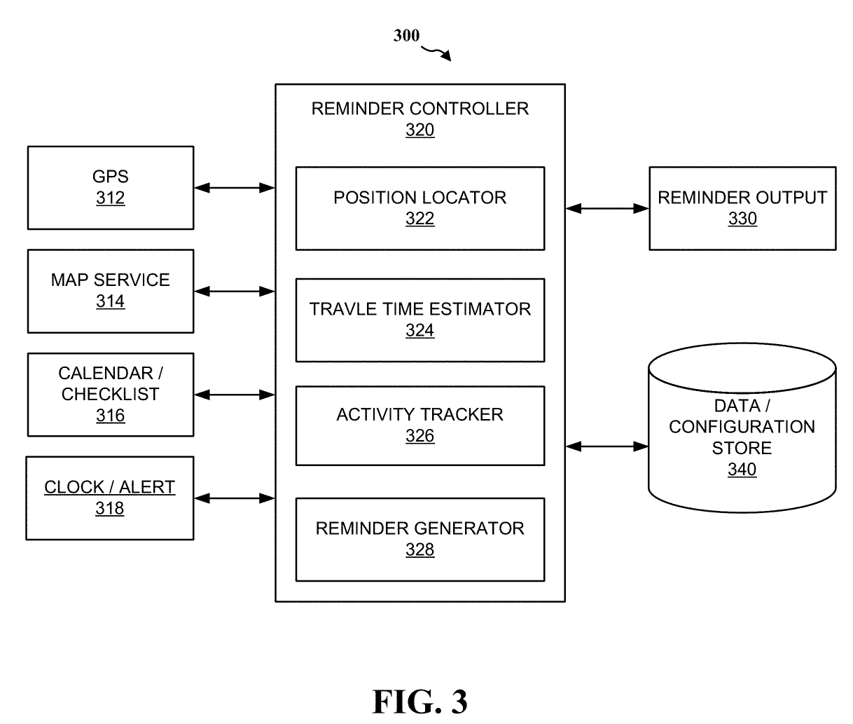

FIG. 3 is a block diagram illustrating components of an example smart reminder application 300 configured to provide a location and activity based reminder, in accordance with aspects of the disclosure. In some implementations, the smart reminder application 300 may include components such as a contacts component, a calendar component, a messaging component, among other components. In other implementations, the smart reminder application 300 may be incorporated into other applications, such as a calendaring application or a messaging application.

In the example shown in FIG. 3, the smart reminder application 300 may include a reminder controller 320, a data/configuration store 340 to store calendaring data and system settings, at least one reminder output 330 and interfaces to other system or software modules, such as a GPS 312, a map service 314, a calendar/checklist application 316, and a clock/alert application 318. The interfaces may be implemented using calls to an application program interface (API) of the corresponding system or software modules. Furthermore, the reminder controller 320 may include a position locator 322, a travel time estimator 324, an activity tracker 326, and a reminder generator 328. Reminder generator 328 may use information determined or obtained by the position locator 322, the travel time estimator 324, and the activity tracker 326 to determine a time when a reminder and a type of the reminder that should be generated. These components are described in more detail below.

In some implementations, the reminder controller 320 can examine information on scheduled events, such as a meeting, an appointment, or an activity stored by the calendar/checklist application 316 in data/configuration store 340 to create or update a reminder for a scheduled event based on the information. For example, information on a meeting may include the participant(s), the meeting location, and the time and date of the meeting. The reminder controller 320 may use the meeting information in determining a reminder time (i.e., a time for triggering a reminder), for example, 15 minutes ahead of the scheduled meeting time.

The reminder controller 320 may also interface with the clock/alert application 318 to determine whether an appointment or an activity is scheduled outside of normal working hours. The reminder generator 328 may take appropriate action, for example, set the reminder time for the end of the working day just prior to the appointment time. In other cases, the reminder generator 328 may also determine whether an appointment falls on a holiday or other special event that otherwise would be within normal working hours to check for potential conflict and to ensure timely reminders.

In some implementations, the reminder controller 320 may retrieve the current location information of the user, and then obtain a travel time estimate for traveling from the user's current location to the location of the scheduled event. For example, the position locator 322 may retrieve a user location via GPS 312 and use the address book stored in data/configuration store 340 to obtain the location of an appointment. The travel time estimator 324 may then determine an estimate of the time needed to travel from the user's current location to the location of the appointment. The estimated travel time may be retrieved from the map service 314, which may provide an estimate of travel time from a start address to a destination address via walking, driving or public transportation options. Alternatively or in addition, the travel time estimator 324 may access a map application on the electronic device and calculate a travel time based on the route, distance and mode of transportation from the user's location to the location of the appointment. The reminder generator 328 may then set the reminder time taking the estimated travel time into consideration.

The reminder controller 320 may include an activity tracker 326 for tracking user activities, which encompass any activity that the user may be engaged in or any activity state of the user. The activity may relate to an action of the user (e.g. watching television) or a passive activity (e.g. being present at a certain location). The activity thus tracked may include a selection of activities that may be carried out by the user that are likely to have an effect on the efficacy of the reminder in the reminder information. For example, in a smart home environment, the user may exercise with a fitness equipment, watch a favorite TV show, or browse the Internet. The fitness equipment, the TV and the personal computer (PC) may detect what actions the user is performing and may provide such information to the activity tracker 326. The reminder generator 328 may retrieve the activity information and generate a reminder at an appropriate time without interrupting the user's exercise session, TV program, or Internet browsing session.

In accordance with other implementations, the smart reminder application 300 may incorporate additional sources of information in determining the reminder time. For example, the reminder controller 320 may be configured to receive alert information via the clock/alert application 318. Reminder generator 328 may then adjust the reminder time in response to the alert information received, such as traffic reports, weather reports, public transit status, and so on. For example, if a normal driving route is blocked due to an accident, in response to an alert of the accident, the reminder generator 328 may suggest an alternative route, recalculate the estimated travel time, and appropriately adjust when the reminder is triggered. In some implementations, the user may also configure smart reminder application 300 to add a specified amount of “lead-time” to all reminders or to a subset of reminders affected by a particular alert before the reminder for associated appointments start.

When the reminder time is reached, reminder controller 320 may trigger the reminder notification via reminder output 330. The reminder notification may be output as an audio signal and/or visual signal and/or vibration signal. For example, the smart reminder application 300 may be configured to send an audio/visual notification to a smartwatch and/or an instant messaging (IM) message or an e-mail to a smart phone or laptop for the event associated with the reminder time.

Although the above-described embodiment has been described in terms of separate modules or components, in other embodiments the functions of the various modules or components may be performed by other modules and/or combined into fewer modules. In still other embodiments, some of the functions performed by the described modules may be separated further into more modules.

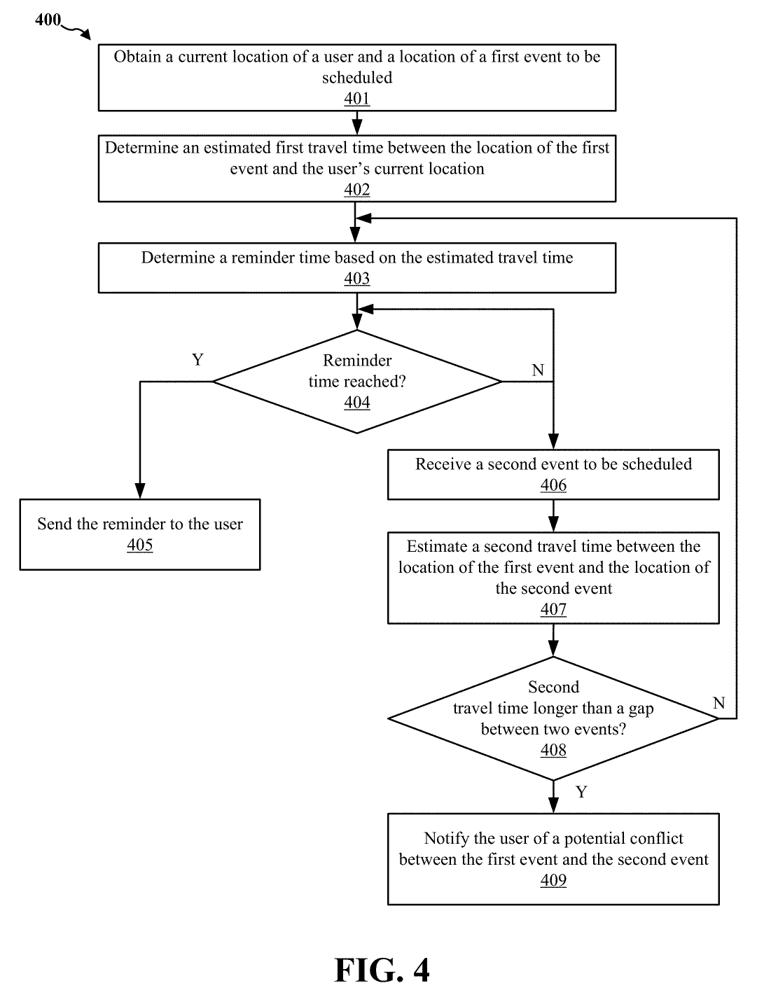

Various scenarios with references to FIGS. 4-6 are described below to illustrate aspects of smart reminder application 300.

FIG. 4 is a flowchart illustrating an example process 400 for scheduling, in accordance with aspects of the disclosure. The process 400 may be performed in any suitable computing environment, such as the electronic device 200 (FIG. 2), to implement smart reminder application 300 (FIG. 3). Therefore, the description of the process 400 may refer to at least one of the components of FIGS. 2 and 3. However, any such reference to components of FIGS. 2 and 3 is for descriptive purposes only, and it is to be understood that the implementations of FIGS. 2 and 3 are a non-limiting environment for the example process 400.

In block 401, a current location of a user and a location of a first scheduled event are obtained by the smart reminder application 300. The first scheduled event can be a meeting, a phone call, an appointment, or any other activities. The first event to be scheduled may be entered into the smart reminder application 300 or detected by the smart reminder application 300 from other applications, such as a calendaring application or a messaging application.

In some implementations, the user location and the event location may be determined by the position locator 322 (FIG. 3) of the smart reminder application 300. For example, the locations can be determined by accessing the data/configuration store 340, the map service 314, the GPS 312, or other suitable location information source (e.g., a cell phone location system).

Other information associated with the event to be scheduled may also be maintained by the smart reminder application 300. The other information may include other attendees of the event, a location of each other attendee, event date and time including start time of the event and end time of the event, the user's working hours, a lead time for the event reminder, among other information.

In block 402, an estimated first travel time from the user's current location to the first event location is determined. In some implementations, the travel time estimator 324 (FIG. 3) of the smart reminder application 300 determines or estimates the travel time from the current user location and the first event location. For example, the travel time estimate may be obtained from the map service 314, or determined based on the distance from the user's location to the location of the first event. The distance may be determined from the map service 314 or other suitable location information sources. In some cases, the mode of transportation, such as walking, biking, or driving may also be considered when making the travel time estimate. Other information, such as real-time information on weather or traffic conditions, may also be used in the estimation of the travel time. Real-time traffic information may indicate traffic conditions such as accidents, road blockages, or slow travel speeds on roads. Weather conditions may indicate situations such as heavy rain, flooding, or snowstorms. Both traffic and weather conditions may increase the amount of time needed to reach the location for the scheduled event, and estimated travel times may be adjusted accordingly.

In block 403, a reminder time is determined based at least in part on the estimated travel time. In some implementations, the smart reminder application 300 determines the reminder time for the first event based on a lead-time, the travel time as estimated at block 402, and whether the event start time is outside of the working hours. For example, if the lead time is ten minutes, the estimated travel time is forty-five minutes and the event date and start time are within working hours, the reminder system may generate a reminder time that is fifty-five minutes before the appointment time.

In another example, if a user named Alice has a meeting scheduled at work on Monday morning at 9:00-10:00 AM, and Alice's home is thirty minutes' drive from work under real-time traffic conditions, the smart reminder application 300 may generate a reminder with the reminder time set at 8:30 AM, if Alice is at home at that time on Monday morning. If Alice arrived at work by 8:00 AM in the morning of the meeting, the smart reminder application 300 may set the reminder time with a lead time of five minutes before the meeting at 8:55 AM. If in this example, Alice is the presenter at the meeting, the smart reminder application 300 may allow a longer lead time, say ten minutes, for Alice to check the presentation setup before the meeting and set the reminder time to 8:50 AM.

In block 404, whether the reminder time has been reached is determined. In some implementations, the smart reminder application 300 checks for the current time. When the current time reaches the reminder time, the smart reminder application 300 generates a reminder and sends the reminder to an electronic device associated with the user in block 405. Otherwise if the reminder time has not been reached, the process returns to the beginning of the block 404.

The smart reminder application 300 can also detect if the travel time for an appointment may cause a conflict between the appointment with other scheduled event occurring either before or after the appointment. Assuming that during the time before the reminder time has been reached at block 404, a second event to be scheduled is received at the smart reminder application 300 in block 406. Similar to the first event, the schedule of the second event may be entered or detected by the smart reminder application 300 from other applications. In block 407, the smart reminder application 300 estimates a second travel time from the location of the first event to the location of the second event. Then, in block 408, whether the estimated second travel time is longer than a gap between two events is determined. If the estimated second travel time is longer than a gap between two events, the smart reminder application 300 generates an alert on a user device to notify (at block 409) the user of potential conflict between the first event and the second event so that the schedule of events may be adjusted accordingly. Otherwise, the smart reminder application 300 may determine a proper reminder time based on the estimated second travel time for the second event, as in block 403.

To continue the previous example for Alice, if a second travel time for an appointment with a client scheduled at 10:30 AM on Monday is forty-five minutes, while the gap between the first meeting, which ends at 10:00 AM, and the appointment time of the appointment with the client is only thirty minutes, the smart reminder application 300 may notify Alice of the timing conflict. Similarly, if Alice would like to schedule a breakfast appointment at 8:00-8:30 AM before the Monday meeting at a restaurant, the smart reminder application 300 may detect that the forty-minute travel time back to work from the breakfast appointment will cause a conflict and notify Alice.

In one configuration, the process 400 may be performed by a UE. The UE may include means for obtaining the current location of a user and a location of a first event to be scheduled. The UE may include means for determining an estimated first travel time between the location of the first event and the user's current location. The UE may include means for determining a reminder time based on the estimated first travel time. The UE may include means for determining whether the reminder time has been reached. The UE may include means for sending the reminder to the user if the reminder time has been reached.

In one configuration, the UE may include means for receiving a second event to be scheduled. The UE may include means for estimating a second travel time between the location of the first event and the location of the second event. The UE may include means for determining whether the second travel time is longer than the gap between the two events. The UE may include means for notifying the user of a potential conflict between the first event and the second event if the second travel time is longer than the gap between the two events.

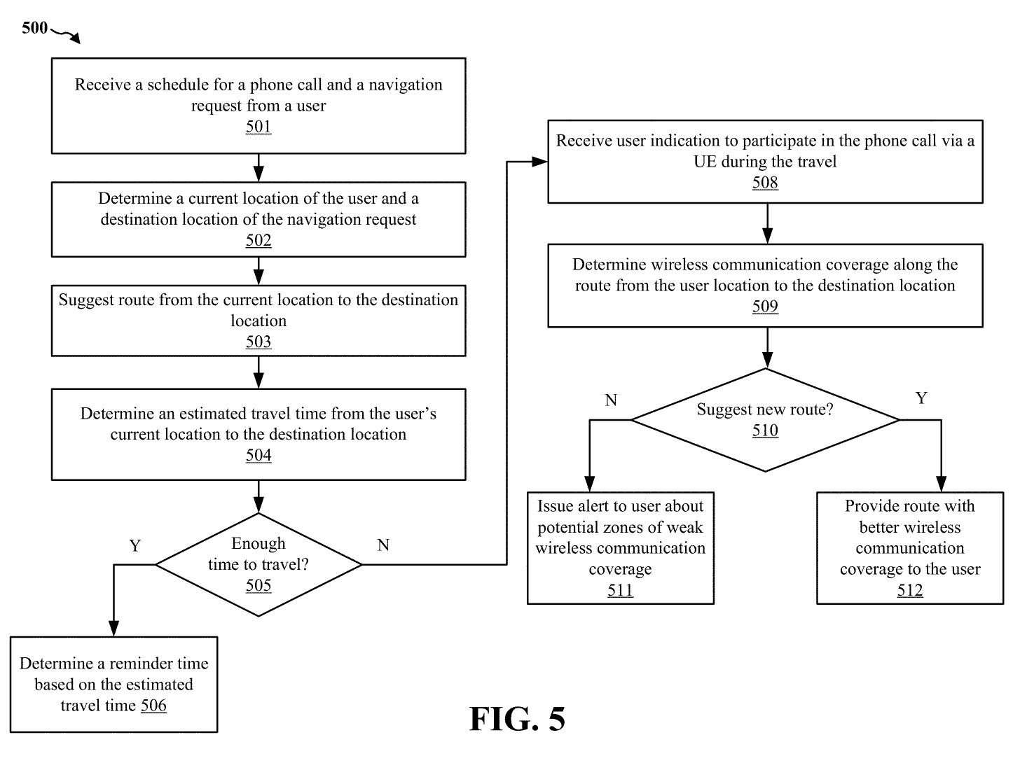

FIG. 5 is a flowchart illustrating an example process 500 for managing activities, in accordance with aspects of the disclosure. The process 500 may be performed in any suitable computing environment, such as the electronic device 200 (FIG. 2), to implement smart reminder application 300 (FIG. 3). Therefore, the description of the process 500 may refer to at least one of the components of FIGS. 2 and 3. However, any such reference to components of FIGS. 2 and 3 is for descriptive purposes only, and it is to be understood that the implementations of FIGS. 2 and 3 are a non-limiting environment for operational flow 500.

In block 501, the smart reminder application 300 receives a schedule for a phone call, as well as a navigation request. The phone call to be scheduled may be entered into the smart reminder application 300 or detected by the smart reminder application 300 from other applications, such as a calendaring application or a messaging application. In some implementations, the navigation request may be passed to a stand-alone navigation application initiated by the smart reminder application 300. Alternatively or in addition, the smart reminder application 300 may initiate an embedded navigation application within the smart reminder application's own program space. Information, such as route selection and traffic conditions, may be exchanged and synchronized between the smart reminder application 300 and the navigation application.

In block 502, the current location of the user and the destination location of the navigation request (e.g., office of the user) are determined. In block 503, routes from the current location to the destination location may be suggested. In some implementations, the user location (e.g., the location where the user will be at the time, or the location where the user will be when the notification is generated) and the destination location may be determined by the position locator 322 of the smart reminder application 300. For example, the locations can be determined by accessing the data configuration store 340, the map service 314, the GPS 312, or other suitable location information source (e.g., cell phone location systems). The routes from one location to the other location may be suggested by the map service 314 or the navigation application initiated by the smart reminder application 300. The route may be suggested based on mode of transportation, real-time traffic conditions and weather conditions.

In block 504, an estimated travel time from the user location to the destination location is determined. In some implementations, the travel time estimator 324 of the smart reminder application 300 determines or estimates the travel time between the locations. For example, the travel time estimate may be obtained from the map service 315, or the navigation application initiated by the smart reminder application 300. In some cases, the mode of transportation, such as walking, biking, or driving, and other information, such as real-time information on weather or traffic conditions, may also affect the estimation of the travel time.

In block 505, whether there is enough time to travel to the destination location before the scheduled time of the phone call based at least in part on the estimated travel time and suggested route is determined. If so determined that there is enough travel time, the smart reminder application 300 may determine (at block 506) a proper reminder time for the phone call based on the travel time as estimated at block 504, among other factors, such as a lead time.

Otherwise if it is determined that the remaining time to the phone call may not allow the user to travel to the destination location (e.g., office), an alert may be displayed on a user device, and the user may be asked to indicate whether the phone call will be participated via a UE during the travel time, for example, while driving or riding public transportation. In block 508, user indication to participate in the phone call via a UE during the travel may be received. The smart reminder application 300 may determine (at block 509) wireless communication (e.g., cellular) coverage along the navigated route from the user location to the destination location. For example, some zones along the navigated route may have strong signal coverage (e.g., with high signal-to-noise ratio (SNR)), other areas may have weaker wireless communication coverage than a threshold for clear voice calls, yet some areas may have more coverage gaps than other areas. The wireless communication (e.g., cellular) coverage along the route may be obtained from the map service 315, the navigation application initiated by the smart reminder application 300, historical reception data stored at data/configuration store 340, or a service provider coverage map.

The smart reminder application 300 may then determine in block 510 whether to suggest a new route based on the cellular coverage determined for the current route in block 509. In case no change to the route is preferred (e.g., by the user), the smart reminder application 300 may issue an alert about potential zones of weak wireless communication (e.g., cellular) coverage along the route in block 511. Otherwise, the smart reminder application 300 may notify the navigation application to provide one or more new routes with better wireless communication coverage (e.g., increased signal SNR or fewer coverage gaps) to the user in block 512.

In one configuration, the process 500 may be performed by a UE. The UE may include means for receiving a navigation request to a destination and an indication to participate in a phone call while traveling to the destination. The UE may include means for determining a current location. The UE may include means for providing a route from the current location to the destination. The UE may include means for estimating wireless communication coverage conditions along the route.

In one configuration, the UE may further include means for receiving a schedule for the phone call. The UE may further include means for estimating a time of arrival to the destination from the current location. The UE may further include means for, in response to determining that the estimated time of arrival is ahead of a start time of the phone call, determining that the phone call is to be participated after arriving at the destination.

In one configuration, the UE may further include means for determining a reminder time based at least in part on the estimated time of arrival. The UE may further include means for sending a reminder at the determined reminder time. In one configuration, the UE may further include means for issuing an alert about zones of wireless communication coverage weaker than a threshold based on the wireless communication coverage conditions along the route. In one configuration, the UE may further include means for providing one or more new routes with increased wireless communication coverages.

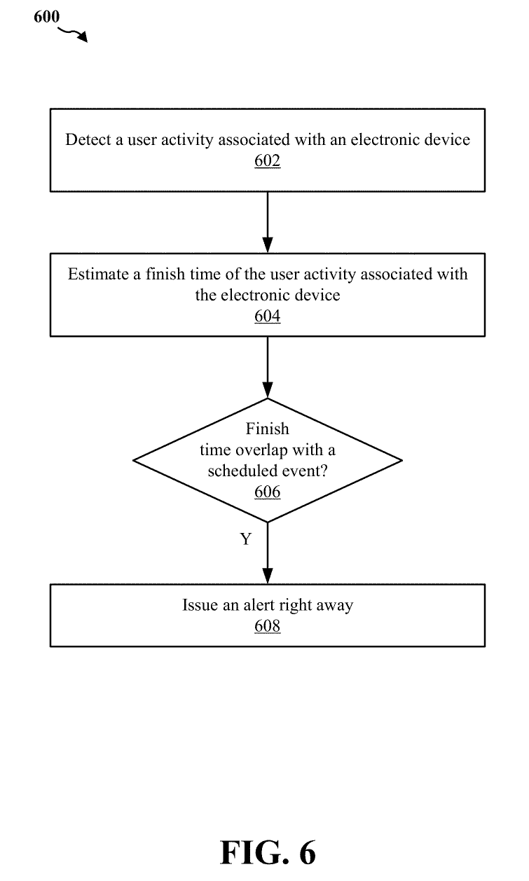

FIG. 6 is a flowchart illustrating an example process 600 for scheduling, in accordance with aspects of the disclosure. The process 600 may be performed in any suitable computing environment, such as the electronic device 200 (FIG. 2), to implement smart reminder application 300 (FIG. 3). Therefore, the description of the process 600 may refer to at least one of the components of FIGS. 2 and 3. However, any such reference to components of FIGS. 2 and 3 is for descriptive purposes only, and it is to be understood that the implementations of FIGS. 2 and 3 are a non-limiting environment for operational flow 600.

In block 602, a user activity associated with an electronic device is detected by the smart reminder application 300. The electronic device may include wearable devices with embedded sensors for capturing user activity information, biometric information, and images and videos, among other information. The one or more sensors may include motion sensors, such as an accelerometer for measuring acceleration, a gyroscope for measuring orientation, or a combination thereof. Alternatively or in addition, the one or more sensors comprise biometric sensors for obtaining the user's biometric information, such as heart rate and blood pressure. The wearable device may detect user activity, such as exercising, walking, sitting stationary or sleeping, and provide the detected activity information to the smart reminder application 300.

The electronic device may also include smart home devices in a smart home environment, such as fitness equipment, a smart TV or a personal computer. The fitness equipment, TV and/or PC may detect what actions the user is performing while using the smart home device, for instance, exercising, watching movies and browsing the Internet, and may provide the information to the smart reminder application 300. Other electronic device may include home surveillance devices, such as motion detectors and video cameras that may capture or record images, voices or videos relating to the user's activities.

In block 604, the smart reminder application 300 estimates a finish time of the detected user activity associated with the electronic device. The finish time of the user activity may be estimated based on the types of detected activities and/or information provided by the electronic device. For example, a smart TV can monitor what is being displayed on the smart TV, such as a TV show, a movie, or a live sports program, and provide the program information (including the finish time) to the smart reminder application 300. As another example, the estimated finish time for an exercise session may be provided by the fitness equipment based on the user input settings of exercise duration and intensity at the beginning of the exercise. The user's daily exercise routine (or habit) may also be taken into account when determining the time window of user activities. For instance, for a user who wakes at 7 am and goes to bed at 11 pm, the finish time of the user's night sleep may be estimated as 8 hours.

In block 606, whether the estimated finish time overlaps with a scheduled event is determined. If the estimated finish time overlaps with a scheduled event, the smart reminder application 300 may issue an alert right away in block 608 so that the activity or the scheduled event may be adjusted accordingly to avoid interruptions of the activity. For example, the smart reminder application 300 may detect that the user has selected a movie for streaming after dinner. The movie runs for around ninety minutes. The activity information may be used to detect if there is a conflict with an upcoming international phone call scheduled later at night. If the phone call is scheduled in sixty minutes, the smart reminder application 300 may notify the user right away about the conflict. The user may delay his movie watching to avoid leaving in the middle of the movie when the phone call starts. The alert issued when the activity is detected may allow the user to plan ahead of time intelligently and ensure no disruption to the user activity.

As another example, an alarm clock may be configured using the smart reminder application 300 to ensure a minimum of seven hours of sleep or a certain amount of deep sleep. Instead of sounding the alarm at a fixed time in the morning, the smart reminder application 300 may obtain information regarding user's sleep through a wearable device, such as a sleep monitor, and trigger the alarm dynamically when the minimum period of sleep or deep sleep has been satisfied. On the other hand, the smart reminder application 300 may cancel the alarm if the smart reminder application detects that the user is awake when the alarm is to be triggered.

In one configuration, the process 600 may be performed by a UE. The UE may include means for detecting a user activity associated with the UE. The UE may include means for estimating a finish time of the user activity. The UE may include means for, in response to determining the estimated finish time falls behind a start time of a scheduled event, issuing an alert to the user about a conflict of the activity with the scheduled event.

In one configuration, the UE may further include means for, in response to determining the estimated finish time falls behind the start time of the scheduled event, providing options for adjusting the start time of the scheduled event. In one configuration, the UE may further include means for receiving an indication to postpone the user activity, and means for sending a reminder at a previously determined reminder time for the scheduled event. In one configuration, the UE may further include means for, in response to detecting a user awake before a scheduled wakeup alarm, cancelling the scheduled wakeup alarm.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of scheduling, comprising:
detecting a user activity associated with an electronic device;
estimating a finish time of the user activity associated with the electronic device; and
in response to determining the estimated finish time falls behind a start time of a scheduled event, issuing an alert about a conflict of the user activity with the scheduled event.

2. The method of claim 1, wherein the electronic device is a wearable device including a smartwatch, a fitness track, and a sleep monitor.

3. The method of claim 1, wherein the electronic device is a smart home device including a smart TV, a fitness equipment, a personal computer, a surveillance camera, and a motion detector.

4. The method of claim 1, further comprising:
in response to determining the estimated finish time falls behind the start time of the scheduled event, providing options for adjusting the start time of the scheduled event.

5. The method of claim 1, further comprising:
receiving an indication to postpone the user activity; and
sending a reminder at a previously determined reminder time for the scheduled event.

6. The method of claim 1, wherein the user activity includes sleeping.

7. The method of claim 6, further comprising:
in response to detecting a user awake before a scheduled wakeup alarm, cancelling the scheduled wakeup alarm.

8. An apparatus for scheduling, comprising:
a memory; and
at least one processor coupled to the memory and configured to:
detect a user activity associated with the apparatus;
estimate a finish time of the user activity; and
in response to determining the estimated finish time falls behind a start time of a scheduled event, issue an alert about a conflict of the user activity with the scheduled event.

9. The apparatus of claim 8, wherein the apparatus is a wearable device including a smartwatch, a fitness track, and a sleep monitor.

10. The apparatus of claim 8, wherein the apparatus is a smart home device including a smart TV, a fitness equipment, a personal computer, a surveillance camera, and a motion detector.

11. The apparatus of claim 8, wherein the at least one processor is further configured to:
in response to determining the estimated finish time falls behind the start time of the scheduled event, provide options for adjusting the start time of the scheduled event.

12. The apparatus of claim 8, wherein the at least one processor is further configured to:
receive an indication to postpone the user activity; and
send a reminder at a previously determined reminder time for the scheduled event.

13. The apparatus of claim 8, wherein the user activity includes sleeping.

14. The apparatus of claim 13, wherein the at least one processor is further configured to:
in response to detecting a user awake before a scheduled wakeup alarm, cancel the scheduled wakeup alarm.

15. A method of managing activities, comprising:
receiving a navigation request to a destination and an indication to participate in a phone call while traveling to the destination;
determining a current location;
providing a route from the current location to the destination; and
estimating wireless communication coverage conditions along the route.

16. The method of claim 15, wherein the current location is determined via a user equipment (UE).

17. The method of claim 15, further comprising:
receiving a schedule for the phone call;
estimating a time of arrival to the destination from the current location; and
in response to determining that the estimated time of arrival is ahead of a start time of the phone call, determining that the phone call is to be participated after arriving at the destination.

18. The method of claim 17, further comprising:
determining a reminder time based at least in part on the estimated time of arrival; and
sending a reminder at the determined reminder time.

19. The method of claim 17, wherein the time of arrival is estimated based on at least one of a traffic condition between the current location and the destination, a weather condition, or a type of transportation.

20. The method of claim 15, wherein the wireless communication coverage conditions along the route are estimated based on information collected from at least one of a search engine, a service provider, or a navigation service.

21. The method of claim 20, further comprising issuing an alert about zones of wireless communication coverage weaker than a threshold based on the wireless communication coverage conditions along the route.

22. The method of claim 20, further comprising providing one or more new routes with increased wireless communication coverages.

23. An apparatus for managing activities, comprising:
a memory; and
at least one processor coupled to the memory and configured to:
receive a navigation request to a destination and an indication to participate in a phone call while traveling to the destination;
determine a current location;
provide a route from the current location to the destination; and
estimate wireless communication coverage conditions along the route.

24. The apparatus of claim 23, wherein the current location is determined via a location of the apparatus.

25. The apparatus of claim 23, wherein the at least one processor is further configured to:
receive a schedule for the phone call;
estimate a time of arrival to the destination from the current location; and
in response to determining that the estimated time of arrival is ahead of a start time of the phone call, determine that the phone call be participated after arriving at the destination.

26. The apparatus of claim 25, wherein the at least one processor is further configured to:
determine a reminder time based at least in part on the estimated time of arrival; and
send a reminder at the determined reminder time.

27. The apparatus of claim 25, wherein the time of arrival is estimated based on at least one of a traffic condition between the current location and the destination, a weather condition, or a type of transportation.

28. The apparatus of claim 23, wherein the wireless communication coverage conditions along the route are estimated based on information collected from at least one of a search engine, a service provider, or a navigation service.

29. The apparatus of claim 28, wherein the at least one processor is further configured to issue an alert about zones of wireless communication coverage weaker than a threshold based on the wireless communication coverage conditions along the route.

30. The apparatus of claim 28, wherein the at least one processor is further configured to provide one or more new routes with increased wireless communication coverages.
